(19) United States
(12) Patent Application Publication
(10) Pub. No.: US 2012/0193041 A1
(43) Pub. Date: Aug. 2, 2012

(54) Multi-Display Dual-Function Shade for Glass Window/Door

(76) Inventor: Feng Sun, Columbia, MD (US)

(21) Appl. No.: 13/014,812

(22) Filed: Jan. 27, 2011

(51) Int. Cl. E06B 9/68; E06B 9/44

(52) U.S. Cl. 160/241

(57) ABSTRACT

A multi-display dual-function shade includes a piece of transparency printed with multiple displaying sections and two motors to roll the transparency onto two parallel rollers. The shade acts as a variable glowing display lit by daylight and provides privacy all the time. Multiple displaying sections provide various displaying effect and allow users to choose a desired amount of daylight through the shade anytime of a day or year. The printed transparency can be detached from one roller and completely rolled up onto the other roller to leave the glass window/door uncovered when needed. The multi-display dual-function shade allows easy insertion of new displaying sections into or replacement of the existing transparency to increase the displaying capacity. An integrated multi-display dual-function shade system can be made by installing the shade between the two panes of the glass window/door. An online server system can be set up to generate the customized shade.

### FIELD OF THE INVENTION

The present invention relates to a glass window/door shade system, and more particularly to a multi-display shade system, which blocks the view from outside and acts as a variable glowing display for the inside lit by daylight by employing the glass window/door of the building.

### REFERENCE CITED

U.S. Pat. No. 5,191,748 March 1993 Baughman
U.S. Pat. No. 7,525,604 April 2009 Xue
U.S. Pat. No. 7,517,583 April 2009 Onishi et al.
U.S. Pat. No. 7,314,079 January 2008 Yano et al.
20110000627 January 2011 Sun, Feng
U.S. Pat. No. 7,596,899 October 2009 Michael et al.
U.S. Pat. No. 6,984,283 January 2006 Noriega, Linda Y
U.S. Pat. No. 5,829,507 November 1998 Pawlowski, Mark
U.S. Pat. No. 6,910,726 June 2005 Chen et al.

### BACKGROUND

Glass window/doors that can transmit a desirable amount of daylight without losing privacy would be beneficial in a variety of applications. Great efforts have been expended to improve the ways and means of the transmission of light through glass window/doors. Common approaches to light control can be: blind sheet shade, light filtering shade, opaque window shade, laminated glass or even electrically controllable transmission and reflection. These shade systems lack the function of generating a glowing display for the inside by utilizing natural daylight. A dual-function shade has been designed to block the view from outside and generate a glowing display for the inside. Although this dual-function shade can be replaced rather easily, it is not intended to be replaced throughout a day. It is well known that some glass window/doors can receive quite different amount of daylight during different time of a day or year. The light-color region of the printed image on the dual-function shade looks fine lit by normal daylight but it could appear overly bright under direct strong sunlight. An approach to resolve the too-bright-display issue could be printing the corresponding image in a dark tone. However, a glowing display that can vary displaying effect or content anytime according to the need of the user would be highly desirable. To the knowledge of the present inventor, there is no dual-function shade can provide users with opportunities to choose different appropriate glowing displays corresponding to different situations throughout a day or year.

### SUMMARY

It is an object of the present invention to provide a multi-display dual-function shade that acts as a variable glowing display in a room lit by natural daylight, and eliminates the view from outside to ensure the privacy all the time even when the inside is lit. Such a multi-display dual-function shade would provide users very substantial opportunities to perfect indoor lighting and decoration. The following embodiments and aspects of thereof are described and they are meant to be exemplary and illustrative, and not limiting the scope.

The multi-display dual-function shade comprises at least one piece of transparency printed with at least two images or one image printed in at least two different tones. The printed image can be a single picture, or a group of selected pictures, borders can be even created between pictures, to acquire the desired appeal. The depth of color of the picture can be chosen to allow a desired amount of light transmitting through the multi-display dual-function shade. Particularly, one displaying section of the multi-display dual-function shade may only include the dark-color image or the light-color image printed in a dark tone. This displaying section may be used when the glass of the window/door receives strong daylight. Conversely, another displaying section of the multi-display dual-function shade may only include the light-color image or the dark-color image printed in a light tone. This displaying section may be used when the glass receives weak daylight. Alternatively, another displaying section of the multi-display dual-function shade may comprise the image having various brightness regions to suit the need of the users.

The multi-display dual-function shade is equipped with two parallel rollers, each coupled with a motor, situated on two opposite sides of the glass window/door to move the printed transparency reversibly across the glass window/door vertically or horizontally. A remote can be used to control the rolling of the transparency by the motors to allow easy selection of the desired display.

The transparency of the multi-display dual-function shade can be releasably connected to the roller by employing a release/closure unit, such as a zipper unit, a snap fastener unit, a hook-and-loop unit or peelable adhesive, and the like, on either end of the transparency. The release/closure unit allows the printed transparency to be detached from one roller then completely rolled up by the other roller to leave the glass window/door uncovered when needed. Users can also remove the printed transparency by releasing two release/closure units on both ends of the transparency and insert a new one by closing the release/closure units.

New sections of display can be easily inserted to the existing multi-display dual-function shade by employing various connection materials, such as tape, adhesive, a snap fastener, a zipper or a hoop-and-loop, and the like. An Ultraviolet (UV) absorbing agent can be added to the transparency to make the multi-display dual-function shade more preferable to the users.

The integrated multi-display dual-function shade and glass window/door system can be obtained by installing the multi-display dual-function shade between the two panes of the glass window/door. In this case, a section of clear transparency may be reserved to roll out across the glass of the window/door for an unblocked view when needed.

An online server system can be set up to print out the multi-display images uploaded by the users to produce customized shades. The server system can provide online picture editing tool and picture library for the users to create their own multi-display dual-function shades. After the user has finalized the picture design, the server can print out the transparency and send the customized multi-display dual-function shade back to the user. After the initial installation of the multi-display dual-function shade, the user may only need to print out the new displaying section part to add to or replace the existing displaying sections without replacing the hardware.

### BRIEF DESCRIPTION OF THE DRAWINGS

Exemplary embodiments are illustrated in referenced figures of the drawings. It is intended that the embodiments and figures disclosed herein be considered illustrative rather than limiting.

FIG. 1 is a front prospective view of a multi-display dual-function shade, which has at least three different displaying sections, employing a light-color displaying section to cover the glass window/door.

FIG. 2 is a view similar to FIG. 1, with the multi-display dual-function shade employing a darkened light-color displaying section to cover the glass window/door.

FIG. 3 is a view similar to FIG. 1, with the multi-display dual-function shade employing a mixed-color displaying section to cover the glass window/door.

FIG. 4 is a front perspective view of a multi-display dual-function shade with the bottom end of the transparency detached from the bottom roller and the transparency completely rolled up upon the top roller to leave the glass window/door uncovered.

FIG. 5 is a front perspective view of an integrated multi-display dual-function shade and glass window/door system with the multi-display dual-function shade installed between the two panes of the glass window/door.

### DETAILED DESCRIPTION

The present invention provides a multi-display dual-function shade for a glass window/door that acts as a variable glowing display during the daytime and provides privacy all day long. The display type and layout of the multi-display dual-function shade can vary over a wide range. In the regard, the following description of the multi-display dual-function shade is presented for purposes of illustration and wide variety of multi-display dual-function shades can be prepared using the principles of the present invention.

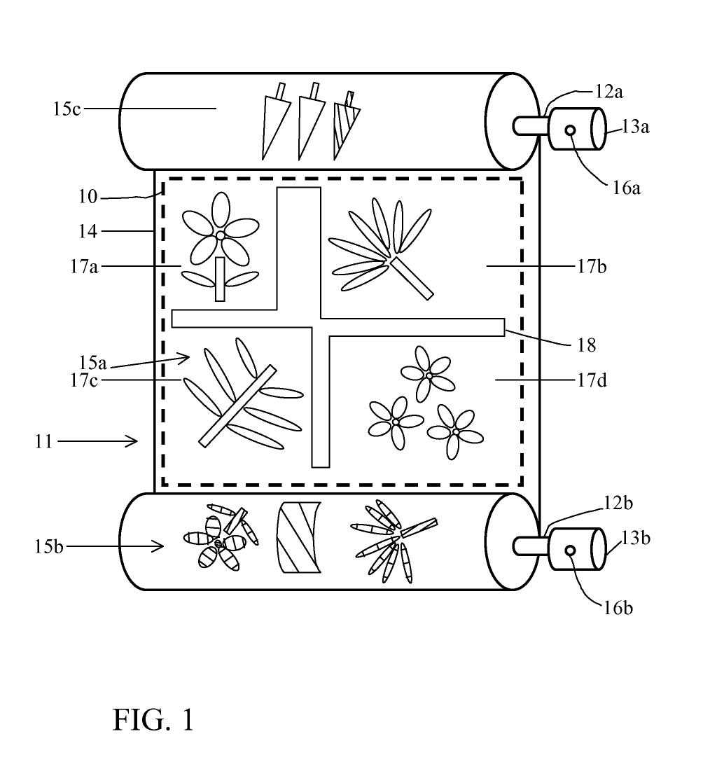

FIG. 1 shows the front perspective view of glass 10 treated by a multi-display dual-function shade 11. The multi-display dual-function shade 11 is constructed from two parallel rollers, top roller 12a and bottom roller 12b, two motors, top motor 13a and bottom motor 13b, transparency 14, and pictures for at least three displaying sections, displaying section 15a, displaying section 15b and displaying 15c, printed on transparency 14. The transparency 14 is rolled onto two rollers, top roller 12a and bottom roller 12b. The top motor 13a winds the transparency 14 upon top roller 12a and moves the transparency 14 upward. The bottom motor 13b winds the transparency 14 upon bottom roller 12b and moves the transparency 14 downward. Two rollers and two motors are supported by suitable bracket (not shown). For the easy selection of the desired displaying section, a remote control can be employed to operate the motors. Shown schematically are two remote receivers, top receiver 16a and bottom receiver 16b, on the motors, top motor 13a and bottom motor 13b, respectively, to enable a hand held transmitter (not shown) to control the moving of transparency 14 reversibly across the glass 10. While a motorized system is employed winding and unwinding the transparency, a manual system could be used although it would be less convenient to the users. The multi-display dual-function shade could also adopt horizontally mounted form beside the illustrated vertically mounted form to satisfy the need of the users.

In the displaying section 15a, four light-color pictures, picture 17a, picture 17b, picture 17c and picture 17d are printed on the transparency 14. Light-color border 18 is created between the pictures to enhance the artistic appeal of the multi-display dual-function shade 11. Instead of four pictures employed in this displaying section, any number could be employed for artistic purposes. Because these light-color pictures in the displaying section 15a allow high transmission of daylight through the glass 10, the displaying section 15a may be used when the glass 10 receives weak daylight.

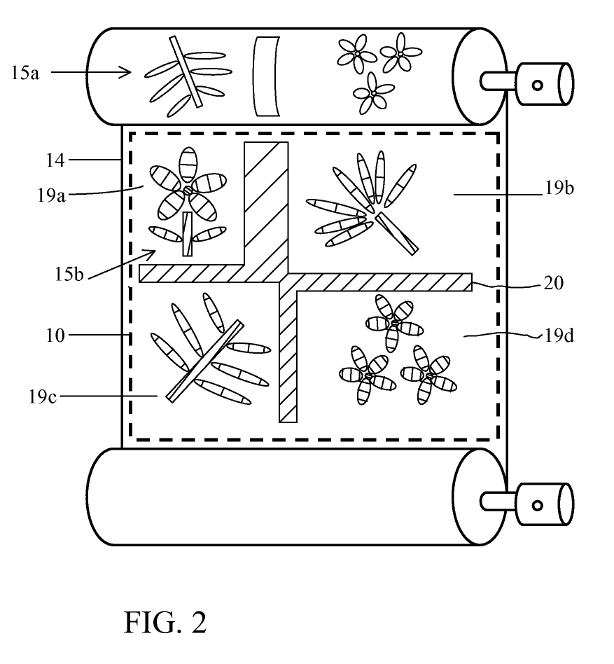

FIG. 2 shows the displaying section 15b after the transparency 14 is rolled upward from FIG. 1 position. In the displaying section 15b, four pictures, picture 19a, picture 19b, picture 19c and picture 19d, and border 20 are printed in a dark tone. Although same pictures are used in the displaying section 15a and the displaying section 15b, other light-color pictures in a dark tone or dark pictures can also be employed. Because dark pictures allow relatively low light transmission through the glass, the displaying section 15b may be used when the glass 10 receives strong daylight.

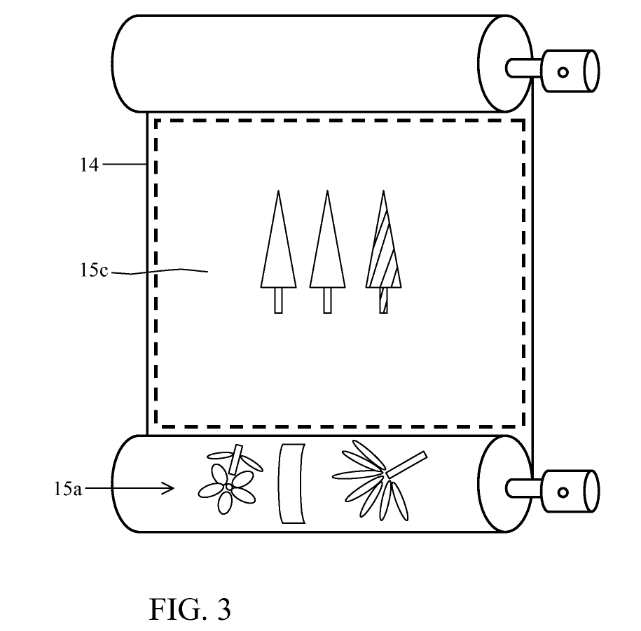

FIG. 3 shows the displaying section 15c after the transparency 14 is rolled downward from FIG. 1 position. The displaying section 15c contains a picture having different brightness regions to suit the need of the users. Although the intensity of daylight plays a role in selecting a displaying section, users can always choose their own pleasing displaying sections for indoor lighting and decoration at any time or on any occasion.

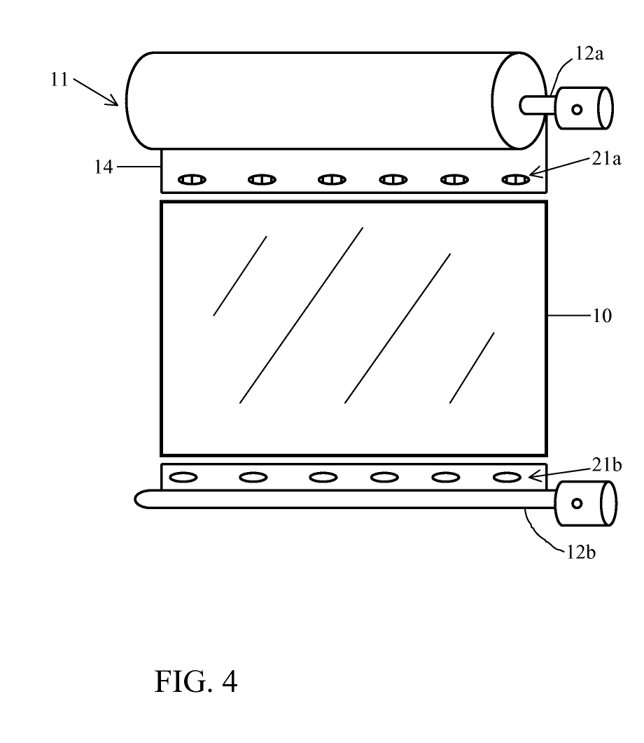

FIG. 4 shows the completely rolled up multi-display dual-function shade 11 to leave the glass 10 uncovered. A release/closure unit, such as a zipper unit, a snap fastener unit, a hook-and-loop unit or releasable adhesive, and the like, is used to releasably connect the transparency to the roller. Each release/closure unit comprises a portion on the transparency side 21a and a portion on the roller side 21b. Two such release/closure units are employed to releasably connect the top end and the bottom end of the transparency 14 to the top roller 12a and the bottom roller 12b, respectively. Therefore, the transparency 14 can be completely detached from one roller, such as the bottom roller 12b, then completely rolled up by the other roller, such as the top roller 12a, to leave the glass 10 uncovered when needed. For easy connecting and disconnecting the transparency from the rollers, the portion of release/closure unit on the transparency side 21a may include a flap on which the release/closure elements are mounted.

New displaying sections for multi-display dual-function shade can be easily attached to the existing transparency using various connection materials, such as tape, adhesive, a snap fastener, a zipper or a hoop-and-loop, and the like. Therefore, the displaying capacity of the multi-display dual-function shade is not limited to the initial setup. Users can even completely remove the existing transparency of the multi-display dual-function shade by releasing two release/closure units on both ends of the transparency. Then users can install a new roll of printed transparency into the multi-display dual-function shade by closing two release/closure units located on two ends of transparency and two rollers. The release/closure units on the multi-display dual-function shade greatly increase the selection of the displaying section for the users. An ultraviolet (UV) absorbing agent can be added to the transparency to make the multi-display dual-function shade more preferable to the users since the daylight becomes mild to human without UV rays.

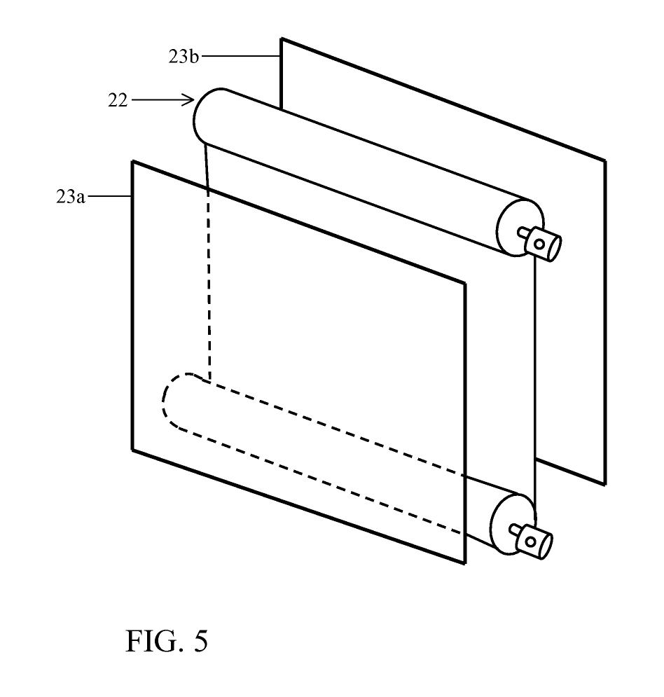

FIG. 5 shows the integrated multi-display dual-function shade and glass window/door system. In the integrated system, the multi-display dual-function shade 22 is installed between the two panes, front pane 23a and back pane 23b, of the glass window/door, and the multi-display dual-function shade 22 is supported by suitable bracket (not shown) mounted on the glass window/door frame (not shown). In this case, a section of clear transparency may be reserved to roll out across the glass of the window/door for an unblocked view when needed.

A still further feature of the present invention is the incorporation of Internet into the making of customized multi-display dual-function shade. The users can upload the image for the multi-display dual-function shade to the server system and let the server system print out the transparency and mail back the customized multi-display dual-function shade. The server system can also provide online picture library and online picture editing tool for the users to design their own various multi-display dual-function shades. After the users have installed the multi-display dual-function shade, they may only need to obtain the transparency printed with the new displaying section and equipped with suitable connection units on both ends of the transparency to insert into or replace the existing transparency without changing the hardware, such as rollers or motors of the multi-display dual-function shade.

What is claimed is:

1. A multi-display dual-function shade for glass window/door, comprising:
a) at least one piece of transparency;
b) one or more pictures generating at least two portions for covering said glass window/door, printed on said transparency;
c) two parallel rollers situated on two opposite sides of said glass window/door.

2. The multi-display dual-function shade of claim 1, wherein said one or more pictures printed on said transparency glow inside lit by the daylight from outside and wherein said one or more pictures printed on said transparency block the view from the outside through said glass window/door, providing privacy all the time.

3. The multi-display dual-function shade of claim 1, wherein said transparency printed with said one or more pictures, is rolled onto said two parallel rollers.

4. The multi-display dual-function shade of claim 3 including a motor means coupled to each of said two parallel rollers for moving said transparency printed with said one or more pictures reversibly across said glass window/door.
